(19) United States
(12) Patent Application Publication
(10) Pub. No.: US 2023/0242433 A1
(43) Pub. Date: Aug. 3, 2023

(54) METHOD AND DEVICE FOR HARVESTING INNER ENERGY FROM EXHAUST GASES

(71) Applicant: Messer Austria GmbH, Gumpoldskirchen (AT)

(72) Inventors: Martin Demuth, Guntramsdorf (AT); Davor Spoljaric, Langenzerdorf (AT); Christoph Hochenauer, Eggersdorf bei Graz (AT); Christian Erich Gaber, Gumpoldskirchen (AT); Philipp Wachter, Graz (AT)

(73) Assignee: Messer Austria GmbH, Gumpoldskirchen (AT)

(21) Appl. No.: 18/002,320

(22) PCT Filed: Jun. 21, 2021
(86) PCT No.: PCT/EP2021/066856

§ 371 Date: Dec. 19, 2022

(30) Foreign Application Priority Data
Jul. 4, 2020 (DE) 10 2020 004 045.4

(51) Int. Cl. C03B 5/237; C01B 3/38; C21B 13/00; F27D 17/00

(52) U.S. Cl. CPC C03B 5/237; C01B 3/38; C21B 13/0073; F27D 17/004; C01B 2203/0233; C01B 2203/0244; C01B 2203/0811; C01B 2203/1058; C01B 2203/1064; C01B 2203/1241; C01B 2203/1294

(57) ABSTRACT

In a thermochemical method, a syngas comprising oxygen is combusted in a furnace, thereby producing a hot exhaust gas. The exhaust gas is subsequently discharged into the surroundings while the inner energy of the exhaust gas is at least partly used to carry out a reformation reaction. For this purpose, steam together with a hydrocarbon-containing fuel and an oxygen-containing gas are supplied to a reformer and converted into syngas in an endothermic reaction using inner energy of the exhaust gas. The heat of the exhaust gas is used in particular to evaporate water and supply same to the reformer in a superheated state. The syngas is then supplied to the furnace as fuel. The invention prevents undesired constituents of the furnace atmosphere, in particular sulfur compounds, from being supplied to the reformer.

### CROSS-REFERENCE TO RELATED APPLICATIONS

The present application is the U.S. national stage application of International Application PCT/EP2021/066856 filed Jun. 21, 2021, which international application was published on Jan. 13, 2022, as International Publication WO 2022/008222 A1. The international application claims priority to German Patent Application No. 10 2020 004 045.4 filed Jul. 4, 2020.

### FIELD

The invention relates to a process for recovering internal energy from hot exhaust gases, in which a hydrocarbon-containing fuel and steam are fed to a reformer in which a synthesis gas containing carbon monoxide and hydrogen is produced in an endothermic reforming reaction and the synthesis gas is subsequently fed to a furnace in which it is combusted with an oxygen-containing oxidizing agent to produce a hot exhaust gas containing carbon dioxide and steam, and the internal energy contained in the exhaust gas is at least partially used to carry out the endothermic reforming reaction in the reformer. The invention further relates to a corresponding device.

### BACKGROUND

Combustion processes in industrial furnace systems produce hot combustion products that are generally discharged as flue or exhaust gases. The internal energy contained in the flue gases is released unused into the environment. In order to be able to recover at least part of the thermal energy and thus increase the combustion efficiency of the furnace system, various approaches have already been developed.

One of these approaches consists of preheating the fuels and oxidizing agents fed to the furnace by heat exchange with the flue gases flowing out of the furnace. The heat can be recovered in particular in regenerators through which the hot flue gas and then the oxidizing agent or fuel flow alternately. The flue gas releases part of its heat to a heat accumulator in the regenerator, which stores it temporarily and then releases it in turn to the oxidizing agent or fuel. Typically, at least two regenerators are used, which are operated alternately, so that one regenerator is always used to absorb the heat from the flue gas and a second regenerator is used to heat the oxidizing agent or fuel.

While this process is often used when air is used as the oxidizing agent and/or at high exhaust gas temperatures of more than 1300° C., or a high loading of dust and aggressive components are present, it entails considerable procedural difficulties in plants in which a fuel is combusted with pure oxygen (oxyfuel plants). On the one hand, only a relatively small amount of heat can be recovered from the exhaust gas due to the different heat capacities and the significantly lower volume flows, and on the other hand, the material is very highly oxidized by the heated oxygen. In addition, the preheating temperature of oxygen is limited to ca. 650° C., which means that only a relatively small percentage increase in combustion efficiency can be achieved with conventional exhaust gas heat recovery. With methane-containing fuels, undesirable methane cleavage also occurs.

In the so-called TCR process (Thermochemical Regeneration/Recuperation), as described for example in EP 0 953 543 A1, this problem is circumvented insofar as the exhaust gas from furnace systems operated with oxygen as oxidizing agent is not only used to preheat the reactants in the furnace, but also partly for internal reforming of the fuel.

For continuous regenerative TCR operation, a furnace is usually connected to at least two reactors, each of which operates successively as a reformer and as regenerator and changes its mode of operation after fixed time intervals in such a way that a first reactor is always in a regeneration phase (heating phase) and a second reactor is always in a reforming phase. The regeneration phase proceeds as in conventional regenerators in that the hot exhaust gas from the furnace transfers part of the heat to a heat accumulator (regeneration bed) of the first reactor. The exhaust gas is cooled in the process and then exits the reactor. Part of the exhaust gas is subsequently diverted and mixed with a hydrocarbon-containing fuel (e.g. CH₄). The non-recirculated exhaust gas portion leaves the system via an appropriate exhaust pipe. The recirculated exhaust gas and the fuel are fed as a mixture or in separate feed lines to the second reactor (reformer), which has been heated by the hot exhaust gases in the previous cycle and in which the reforming phase is now initiated. In this process, the fuel is chemically converted (reformed) with steam and carbon dioxide to give a synthesis gas containing carbon monoxide and hydrogen, which is then combusted in the furnace with oxygen. Since the exhaust gas produced during the combustion of the synthesis gas in the furnace consists largely of steam and carbon dioxide, this is recycled to the reformer in a partial flow and used directly for the reforming process.

When reforming methane with a recirculated partial stream of the furnace exhaust gas, the so-called steam and dry reforming essentially takes place in the reformer. The reactions thereof are highly endothermic and require high temperatures and low pressures in order to shift the equilibrium to the product side and thus to be able to achieve a high production yield:

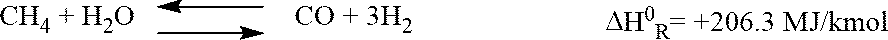

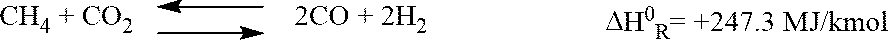

In the case of pure methane as fuel, the composition of the reformable fuel/exhaust gas mixture enables a complete (stoichiometric) conversion to synthesis gas at an exhaust gas recirculation of 25%. The reaction equation of the overall chemical reaction that takes place, also referred to as “bi-reforming”, modelled for oxyfuel combustion without excess air is:

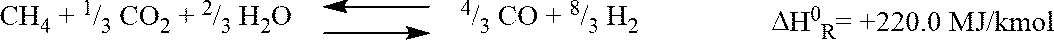

However, only in furnaces with sufficiently high exhaust gas temperatures is the internal energy contained in the exhaust gas sufficient under optimal conditions to ensure at least almost complete conversion of the fuel into synthesis gas. If the exhaust gas temperatures are too low, only part of the fuel is reformed.

In the partially reformed region, solid carbon accumulates at lower reaction temperatures due to the corresponding chemical equilibrium states, which can accumulate in particular on the surface of the catalyst and impair the operability of the reactor. In order to avoid such carbon deposits, EP 0 953 543 A1 proposes to pass the oxygen required for the combustion of the synthesis gas at least partially through the reactor after the reforming phase and before the regeneration phase in order thus to burn off the carbon deposits. However, burning off the carbon results in an additional process step and thus in a delay in the process sequence. In addition, when high-purity oxygen is passed through, the reaction with the carbon leads to undesirably high temperatures locally in the reactor, which have to be countered by mixing exhaust gas from the combustion process with the oxygen supplied, which reduces the efficiency of the process.

Known from DE 10 2016 015 012 A1 is a process for heat recovery from a flue gas produced by a burner, in which the flue gas is at least partially recirculated. In this process, the flue gas is fed to a reformer as a reforming reactant together with a fuel and is converted to a synthesis gas in a reforming reaction with the aid of the internal energy transferred from the flue gas. The synthesis gas is then combusted in the burner, producing flue gas. In a specific configuration of this process, it is intended to use a further part of the thermal energy of the flue gas to evaporate water and to use the steam generated in the reformer, together with the recirculated flue gas and the fuel, to produce the synthesis gas.

EP 3 447 025 A1 describes a thermochemical process in which a synthesis gas is combusted with oxygen in a furnace to produce a hot exhaust gas and a partial flow of the exhaust gas is fed to a reformer together with a hydrocarbon-containing fuel. In the reformer, fuel and the partial flow of the exhaust gas are converted in an endothermic reaction to synthesis gas, which is then fed to the furnace as fuel. In addition to the fuel and the recirculated exhaust gas, oxygen is fed to the reformer as a reactant, wherein, in the case of methane as fuel, for example, the following reaction takes place (“tri-reforming”):

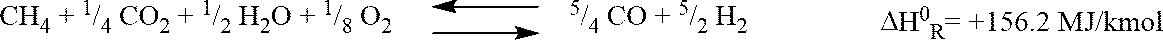

In particular, the oxygen supplied prevents the formation of carbon deposits in the reformer and thus increases the efficiency of the process.

Such processes have been proven, especially if more stable process conditions can be established by using a catalyst in the reformer, for example nickel on a support material of aluminum oxide (Ni/AI₂O₃), and the start of the endothermic chemical reaction can be achieved at lower temperatures by reducing the activation energy. However, it has been found that in many applications sulfurous exhaust gases are produced, which are detrimental to the use of a catalyst. Especially when used in glass melting furnaces, sulfur is not only present in many raw materials, but also in frequently used fluxes.

### SUMMARY

The object of the present invention, therefore, is to improve the thermochemical process described for regenerative/recuperative heat recovery to the extent that an accumulation in the reformer of substances arising during combustion and harmful to the process, in particular sulfur or sulfur compounds, is avoided as far as possible.

This object is achieved by a process and a device with the features of the independent claims. Advantageous configurations of the invention are stated in the dependent claims.

In contrast to processes according to the prior art, in the process according to the invention the exhaust gas from the furnace is only used for heat transfer and is subsequently completely discharged into the environment and not fed back to the reformer in a partial flow. The steam required for the reforming reaction is generated from water, which is fed from a feed line, evaporated in an indirect heat exchanger (recuperator) using internal energy of the furnace exhaust gas and then fed to the reformer. The exhaust gas and the reactants of the reforming reaction are thus strictly separated materially from each other. As a result, no impurities from the furnace exhaust gases, such as sulfur compounds in particular, enter the reformer, which could impair the functionality of a catalyst present therein. Only the internal energy of the exhaust gas is used as an energy source for the reforming reaction in the reformer.

In the reformer, the hydrocarbon-containing fuel, for example methane, is reacted with the steam and optionally oxygen. This produces the synthesis gas consisting mainly of hydrogen and carbon monoxide. In contrast to the “bi-reforming” and “tri-reforming” processes described above, no carbon dioxide is thus fed to the reformer in the process according to the invention, but rather external steam, and a process based on steam reforming is carried out:

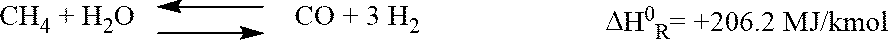

At higher temperatures, the water-gas shift reaction also occurs:

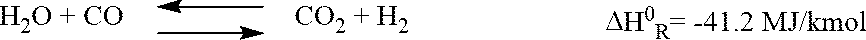

If additional oxygen is added to the reformer, partial oxidation of fuel components also takes place. This also produces CO₂. This is also converted to hydrogen and carbon monoxide by dry reforming. The partial oxidation reduces the enthalpy of reaction. This reduces the energy required for the endothermic reforming reaction, so that a higher temperature is achieved overall in the reformer. In addition, the tendency to form carbon deposits in the reformer is considerably reduced. The oxygen is preferably fed to the reformer in the form of an oxygen-containing gas.

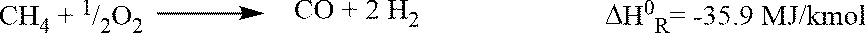

According to the invention, the “oxygen-containing gas” used in the reformer and the “oxygen-containing oxidizing agent” used in the furnace is in each case a gas having an oxygen content equal to or greater than the oxygen content of air. Preferably, both the oxygen-containing gas and the oxygen-containing oxidizing agent are oxygen at a purity of 95% by volume or more (hereinafter also referred to as “pure oxygen”). If the same oxygen-containing gas is used in the reformer and in the furnace, this can be taken from a common source, for example a tank or a pipeline; however, oxygen-containing gases of different composition and/or origin can also be used in the reformer and in the furnace.

In addition to evaporating the water, the internal energy of the exhaust gas can be used to heat the fuel and/or the oxygen-containing gas before feeding thereof to the reformer. The transfer of internal energy from the exhaust gas takes place at indirect heat exchangers (recuperators), which are arranged in the respective supply lines upstream of the reformer. During the evaporation of the water to be fed to the reformer, the resulting steam is expediently brought to a saturated or superheated state by the exhaust gas heat.

In addition to the aforementioned use of the exhaust gas heat for heating the reactants of the reforming reaction, a particularly advantageous configuration of the invention provides for a part of the internal energy of the exhaust gas to be transferred directly to the reaction partners of the reforming reaction present in the reformer. This takes place at a heat exchanger surface arranged in the reformer, which is, for example, the tubes of a heat exchanger arranged in the reformer through which the exhaust gas flows or another indirect heat exchanger which allows continuous heating of the reformer by furnace exhaust gas and thus a recuperative mode of operation.

Preferably, the reaction temperature in the reformer, or, in the case of a multi-part reformer, the temperature in at least one reactor or functional section of the reformer, is between 700° C. and 900° C., particularly preferably between 750° C. and 800° C. The temperature in the reformer - with an otherwise constant supply of heat - is influenced in particular by the ratios of the mass flows of the reactants in the reformer and these can be used to adjust it accordingly.

The mass flow rates of the reactants fed to the reformer, i.e. fuel, steam and oxygen-rich gas, are selected depending on the existing exhaust gas temperature in such a way that, on the one hand, the highest possible conversion of the fuel to synthesis gas takes place and, on the other hand, the formation of carbon deposits in the reactor is avoided and the highest possible enthalpy of reaction is achieved. The reforming of methane with steam according to equation (e) is usually carried out with an excess of water in order to avoid carbon formation. However, this leads to a “dilution” of the synthesis gas to be produced and subsequently to a reduced increase in combustion efficiency. The addition of oxygen to the reactants makes it possible to reduce the water content depending on the existing exhaust gas temperature in such a way that a carbon-free mode of operation with a simultaneously high yield of CO and H₂ can be achieved.

Preferably, in the case of a fuel consisting predominantly of methane, such as natural gas, the ratio of the molar mass flows is [ṅ(CH₄)/ṅ(O₂)/ṅ(H₂O)] = [1/0 - 0.6/0.5 - 1.5], wherein a ratio of the molar mass flows [ṅ(CH₄)/ṅ(O₂)/ṅ(H₂O)] = [1/0.1 - 0.5/0.6 - 1.2] leads to particularly favorable results. Preferably, the oxygen content of the reactants fed to the reformer is between 0 and 25% by volume. At oxygen contents above this, combustion predominates and a synthesis gas enriched with high proportions of carbon dioxide and steam is fed to the furnace.

By incorporating a catalyst in the reformer, more stable process conditions can be created and the activation energy of the chemical reaction can be reduced, whereby the start of the endothermic chemical reaction is achieved at lower temperatures. In particular, catalysts of the group of iron, cobalt, nickel or platinum can be used here, whereby nickel catalysts are advantageously used, for example a catalyst in the form of bulk nickel on a support of aluminum oxide (Ni/AI₂O₃). This facilitates conducting the endothermic chemical reaction at a temperature between 700° C. and 900° C.

A device according to the invention for recovering internal energy from hot exhaust gases comprises a reformer equipped with a feed line for a fuel and with a feed line for an oxygen-containing gas, a furnace equipped with a feed line for an oxygen-containing oxidizing agent and an exhaust gas line for discharging exhaust gas from the furnace, a feed line connecting the reformer to the furnace for feeding a synthesis gas produced in the reformer into the furnace, and at least one heat exchanger for transferring internal energy from the exhaust gas to reaction products in the reformer, the exhaust gas line being thermally connected to an evaporator which is flow-connected to a water feed line separated from the exhaust gas line in terms of flow and to a feed line for steam opening into the reformer and which has a heat exchanger surface for evaporating the water supplied via the water feed line by heat contact with the exhaust gas supplied from the exhaust gas line.

The device intended in particular for carrying out the process according to the invention thus does not have a partial circuit of the exhaust gas generated in the furnace; rather, the exhaust gas leaves the system and reaches the outside atmosphere completely, optionally after passing through a purification stage, via a chimney or is fed to another use outside the thermochemical process. The water required for the reforming reaction is fed in via the water feed line, which is fluidically separated from the exhaust gas line, evaporated in the evaporator by means of the internal energy of the exhaust gas and fed to the reformer as preferably superheated steam.

In addition, further indirect heat exchangers can be provided in the exhaust gas line for heating fuel and/or oxygen-rich gas to be fed to the reformer. In the reformer, a synthesis gas is produced from the steam, fuel and oxygen, which is then combusted in the furnace with an oxidizing agent to produce the exhaust gas.

Preferably, a heat exchanger is arranged in the reformer, which allows transfer of internal energy from the exhaust gas to the reaction products present in the reformer.

This can be, for example, a bed provided in the reformer (regenerator bed), through which in a first operating phase the exhaust gas flows and which is thus heated (regeneration), and in a subsequent operating phase releases the absorbed heat to the reaction partners of the endothermic reforming reaction (reformation). In this case, the reformer comprises two preferably structurally identical reactors which are operated alternately as regenerator and as reformer. However, this mode of operation has the disadvantage that, over time, undesirable constituents of the furnace atmosphere, for example sulfur or sulfur compounds, can accumulate in the reformer and subsequently damage the catalyst in particular.

However, a preferred variant of the invention compared to such a regenerative mode of operation provides for the reformer to be operated as a recuperator. When operating as a recuperator, an indirect heat exchanger is provided in the reformer, through which the furnace exhaust gas flows and which transfers internal energy from the furnace exhaust gas to the reaction products in the reformer at a heat exchanger surface, without any material mixing of furnace exhaust gases and reaction products. For example, the recuperator is a shell-and-tube heat exchanger in which the hot furnace exhaust gas is passed through tubes that extend through a shell space charged with the reaction products of the reforming reaction. However, other recuperator types are also conceivable, such as a gap recuperator, or a tube-basket recuperator, or a combination of several recuperator types. Moreover, in this configuration, an additional device, for example an electric heating device, can be provided by means of which the reformer can be heated and thus the mixture can be brought to reaction temperature. A heating device can also be provided in the evaporator in order to start or support the evaporation process.

In an advantageous configuration of the invention, the reformer is a multi-part reformer in which the reforming reaction takes place in two or more steps in successively connected reactors or functional sections of the reformer. Heat exchangers may be provided in or between at least some of the individual reactors or functional sections, in which some of the internal energy of the exhaust gas is transferred to the reaction partners present in the respective reactor or functional section. In addition, steam and/or the oxygen-containing gas (pure oxygen) can also be fed to the individual reactors or functional sections of the reformer in substreams via corresponding feed lines.

In another advantageous configuration of the invention, a control system is included which is operatively connected to the feed lines and by means of which the mass flow rates of the reactants of the reforming reaction in the reformer can be varied. The control system comprises, for example, an electronic control unit which is data-connected to valves arranged in the feed lines of the reactants and by means of which the mass flows of fuel, oxygen-rich gas and steam can be adjusted according to a predetermined program or depending on measured parameters. In particular, the temperature(s) of the reactants or products before, during or after passing through the reformer, for example the temperature of the furnace exhaust gas or of the supplied steam or oxygen, or for example the composition of the synthesis gas, can be considered as measured parameters. If a multi-part reformer is used, temperatures of the reactants or products before, during or after one or more stages of the reforming process can in particular also be the basis for controlling the mass flows to be supplied.

The process or device according to the invention makes it possible to increase the combustion efficiency of furnaces operated as oxyfuel plants with medium to high exhaust gas temperatures between 700° C. and 1700° C. by up to 25%. The process is particularly suitable for glass melting furnaces or other furnace systems used for high-temperature applications; especially in glass melting furnaces, it prevents problems with acid formers or halogen compounds, such as sulfur, chlorine or fluorine compounds, which are formed during the melting process and are discharged via the exhaust gas of the furnace.

### DESCRIPTION OF THE DRAWING

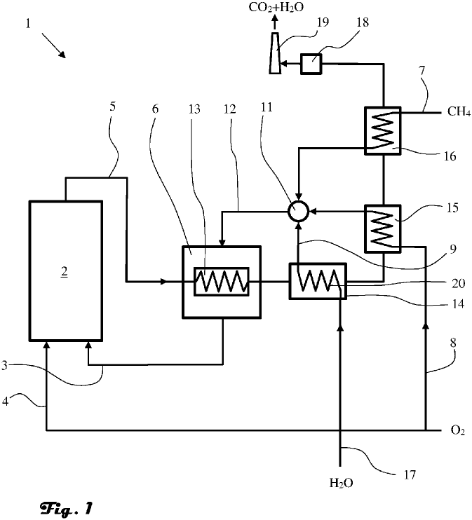

A working example of the invention will be explained in more detail on the basis of the figure. The single figure (FIG. 1) schematically shows a diagram of the mode of operation of a device according to the invention.

### DETAILED DESCRIPTION

The device 1 shown in FIG. 1 comprises a furnace 2, for example a glass melting furnace, which is equipped with a feed line 3 for a synthesis gas and a feed line 4 for an oxidizing agent, and with an exhaust gas line 5 for discharging the exhaust gas produced in the furnace 2 during combustion of the synthesis gas with the oxidizing agent. The synthesis gas is produced in a reformer 6, which is flow-connected to the furnace 2 via the feed line 3. The reformer 6 is in flow connection with a feed line 7 for a hydrocarbon-containing fuel, such as methane, natural gas, fuel oil or the like, with a feed line 8 for an oxygen-containing gas and a feed line 9 for steam.

The oxygen-rich gas used in the working example shown here is the same gas that is used as an oxidizing agent in the furnace 2, for example oxygen having a purity of 95% by volume or above. For this reason, the feed lines 4, 8 are connected to each other and to a common source not shown here, for example an oxygen tank or a pipeline; however, it is also conceivable that different oxygen-containing gases are used in the furnace 2 and in the reformer 6; in this case, the feed lines 4, 9 are connected to different sources.

In the working example shown here, the feed lines 7, 8, 9 open together into a mixer 11, from which a common feed line 12 transports the gas mixture into the reformer 6; in the scope of the invention, however, it is also conceivable that the feed lines 7, 8, 9 open directly into the reformer 6.

In order to increase the efficiency of the reaction taking place in the reformer 6, this is equipped with a catalyst in a manner not shown here, which is nickel for example, which is applied to an inert support material in the form of bulk material.

During operation of the device 1, a synthesis gas containing carbon monoxide and hydrogen is produced in the reformer 6 from the reactants methane, oxygen and steam in an endothermic reforming reaction, the synthesis gas being fed to the furnace 2 via the feed line 3 and combusted in the furnace 2 with the oxidizing agent supplied via the feed line 4. The resulting exhaust gases are discharged via the exhaust gas line 5. They contain carbon dioxide and steam, but may also contain other constituents such as oxygen. The temperature of the exhaust gases is, for example, 1000° C. to 1650° C., preferably 1400° C. to 1500° C.

In order to be able to use the heat of the exhaust gas, the exhaust gas line 5 passes through a series of heat exchangers 13, 14, 15, 16 downstream of the furnace 2, each of which is, for example, a tube, gap or tube-basket recuperator. In a first heat exchanger 13, heat contact takes place in the reformer 6 at a heat exchanger surface between the exhaust gas passed through the exhaust gas line 5 with the reaction products, thereby providing at least part of the heat required for the endothermic reforming reaction. The continuous supply of heat from the exhaust gas to the heat exchanger surface in the heat exchanger 13 enables the operation of the reformer 6 as a recuperator. The still hot exhaust gas is then fed to an evaporator 14. In the evaporator 14 there is a heat exchanger surface 20 on which at least part of the internal energy present in the exhaust gas is transferred to water, which is conveyed to the evaporator 14 via a water feed line 17. The water evaporates at the heat exchanger surface 20 and is then introduced into the reformer 6 in the form of superheated steam via the feed line 9. Optionally, the exhaust gas then passes through heat exchangers 15, 16, in which preheating of the two remaining reactants, oxygen and fuel, takes place.

In none of the heat exchangers 13, 14, 15, 16 is there any material mixing of exhaust gas from the exhaust gas line with any of the media conveyed in the feed lines 7, 8, 9, 17; rather, the exhaust gas cooled in the heat exchangers 13, 15, 16 and the evaporator 14 is discharged from the exhaust gas line 7 into the ambient atmosphere via a chimney 19 after passing through a purification stage 18 or is fed to some other use.

The mass flow rates of the reactants supplied via the feed lines 7, 8, 9 can be varied and the ratios can be adjusted to the conditions by means of a control system not shown here, for example in order to bring about the most complete possible conversion of the fuel in the reformer 6 and at the same time to reduce or completely prevent the tendency to form carbon deposits.

Due to the fluidic separation between the furnace exhaust gas on the one hand and the reactants of the reforming reaction on the other hand, the device 1 reliably prevents harmful constituents of the exhaust gas, for example sulfur compounds, from accumulating in the reformer and causing damage therein, for example to the catalyst bed. By transferring internal energy from the furnace exhaust gases to the reaction products of the reforming reaction at the heat exchangers 13, 15, 16 and the evaporator 14, a high energy efficiency is nevertheless achieved.

### LIST OF REFERENCE SIGNS

1. Device
2. Furnace
3. Feed line
4. Feed line
5. Exhaust gas line
6. Reformer
7. Feed line (for fuel)
8. Feed line (for oxygen)
9. Feed line (for water)
10. -
11. Mixer
12. Common feed line
13. Heat exchanger
14. Evaporator
15. Heat exchanger
16. Heat exchanger
17. Water feed line
18. Purification stage
19. Chimney
20. Heat exchanger surface

1. A process for recovering internal energy from hot exhaust gases in which a hydrocarbon-containing fuel and steam are fed to a reformer, in which a synthesis gas containing carbon monoxide and hydrogen is produced in an endothermic reforming reaction and the synthesis gas is then fed to a furnace, in which it is combusted with an oxygen-containing oxidizing agent, wherein a hot exhaust gas containing carbon dioxide and steam is produced, and the internal energy contained in the exhaust gas is at least partially used to carry out the endothermic reforming reaction in the reformer,
wherein the exhaust gas is completely discharged and the steam used in the reforming reaction is generated from water which is supplied from a feed line, evaporated in an evaporator using internal energy of the exhaust gas and is then fed to the reformer.

2. The process as claimed in claim 1, wherein an oxygen-containing gas is fed to the reformer, which is used in the reforming reaction to generate the synthesis gas.

3. The process as claimed in claim 2, wherein internal energy of the exhaust gas from the furnace is at least partially used for heating the fuel and/or the steam and/or the oxygen-containing gas prior to the respective feeding thereof to the reformer.

4. The process as claimed in claim 1, wherein the internal energy of the exhaust gas from the furnace is at least partially transferred to the reactants of the reforming reaction present in the reformer in a heat exchanger arranged in the reformer.

5. The process as claimed in claim 1, wherein the reaction temperature in the reformer, or in a reactor or a functional section of the reformer, is between 700° C. and 900° C., preferably between 750° C. and 800° C.

6. The process as claimed in claim 1, wherein a fuel consisting at least predominantly of methane is used as fuel and the ratio of the mass flows of the reactants fed to the reformer for the reforming reaction is [ṅ(CH₄)/ṅ(O₂)/ṅ(H₂O)] = [1/0-0.6/0.5-1.5], preferably [ṅ(CH₄)/ṅ(O₂)/ṅ(H₂O)] = [1/0.1-0.5/0.6-1.2].

7. The process as claimed in claim 1, wherein a catalyst from the group of iron, cobalt, nickel or platinum is provided in the reformer.

8. A device for recovering internal energy from hot exhaust gases, the device having:
a reformer connected to a feed line for a hydrocarbon-containing fuel and a feed line for oxygen;
a furnace which is equipped with:
a feed line for an oxygen-containing oxidizing agent;
an exhaust gas line for discharging exhaust gas from the furnace; and
a feed line connecting the reformer to the furnace for feeding a
synthesis gas produced in the reformer into the furnace; and at least one heat exchanger for transferring internal energy of the exhaust gas to reaction products in the reformer;
wherein the exhaust gas line is thermally connected to an evaporator, which is fluidically connected to a water feed line fluidically separated from the exhaust gas line and to a feed line for steam opening into the reformer, and has a heat exchanger surface for evaporating the water supplied via the water feed line by thermal contact with the exhaust gas supplied from the exhaust gas line.

9. The device as claimed in claim 8, wherein a heat exchanger is provided in the reformer for transferring internal energy from the exhaust gas to the reaction products present in the reformer.

10. The device as claimed in claim 9, wherein an indirect heat exchanger connected to the exhaust gas line is provided in the reformer, at which the reaction products of the reforming reaction in the reformer can be brought continuously into thermal contact with the exhaust gas from the furnace.

11. The device as claimed in claim 8, wherein a multi-part reformer consisting of a plurality of reactors and/or functional sections is used as the reformer, wherein the reactors and/or functional sections are at least partially equipped with a heat exchanger for transferring internal energy from the exhaust gas to the respective reaction products and/or with a feed line for steam and/or a feed line for oxygen-containing oxidizing agent.

12. The device as claimed in claim 8, further comprising a control system operatively connected to the feeds by means of which the mass flows of the reactants of the reforming reaction in the reformer can be varied.

13. The device as claimed in claim 8, wherein the furnace is a glass melting furnace.
